(19) United States
(12) Patent Application Publication
(10) Pub. No.: US 2018/0097698 A1
(43) Pub. Date: Apr. 5, 2018

(54) BUILDOUT AND TEARDOWN OF EPHEMERAL INFRASTRUCTURES FOR DYNAMIC SERVICE INSTANCE DEPLOYMENTS

(71) Applicant: Microsoft Technology Licensing, LLC, Redmond, WA (US)

(72) Inventors: Jeremy Haubold, Portage, IN (US); Randee Bierlein Wallulis, Snohomish, WA (US); Senthuran Kandiah, Bothell, WA (US); Shepherd Walker, Seattle, WA (US); Manson Ng, Seattle, WA (US)

(21) Appl. No.: 15/286,076

(22) Filed: Oct. 5, 2016

(51) Int. Cl. H04L 12/24

(52) U.S. Cl. CPC H04L 41/0846; H04L 41/0806

(57) ABSTRACT

The techniques described herein facilitate dynamic buildout and teardown of ephemeral infrastructures for deploying service instances using fungible compute resources. Among other capabilities, a resource management fabric is described that uses a complex service definition that describes a large scale production web or data service and a set of fungible, elastic compute resources to dynamically buildout an instance of the service or application that adheres to the requirements of the service definitions. An operating environment can be generated that describes the ephemeral infrastructure for the deployed service instance. Valuably, the generated operation environment is fundamentally the same environment, e.g., with the same settings, configurations, and network layouts, as a real, production instance of the application or service.

### BACKGROUND

Large-scale production web and data applications or services typically require multiple machines executing various different software configurations that are built out in conjunction with one another in order to properly function. To deploy these applications or services during verification and testing phases, developers have to explicitly maintain and provide information regarding various machines, e.g., machine names, systems, software, and even network layout infrastructure or topology.

Unfortunately, maintaining these configurations and settings can be exceedingly difficult and time consuming for developers. Consequently, developers may attempt to utilize a dedicated environment with static configurations and settings for dedicated compute resources to perform functional testing. However, in each case lack of explicit knowledge regarding one or more of the configurations or settings results in functional tests that are not executing in the same environment, e.g., with the same settings, configurations, and network layouts, as would a real, production instance of the application or service.

Overall, the examples herein of some prior or related systems and their associated limitations are intended to be illustrative and not exclusive. Upon reading the following, other limitations of existing or prior systems will become apparent to those of skill in the art.

### Overview

Examples discussed herein relate to dynamic buildout and teardown of ephemeral infrastructures for deploying service instances using fungible compute resources. In an implementation, a method of operating a management fabric to dynamically build an ephemeral infrastructure for deploying a service instance using fungible compute resources is disclosed. The method includes receiving a resource allocation request including service definitions identifying service parameters for provisioning the service instance and determining availability of the fungible compute resources. The method further includes dynamically generating an operating environment for the service instance in accordance with the service definitions when sufficient compute resources are available. The operating environment identifies resource context information including a set of compute resources of the fungible compute resources and network layout parameters associated with the service instance.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 depicts a block diagram illustrating an example operational architecture for dynamically building out an ephemeral infrastructure for deploying a service instance using fungible compute resources of a compute fabric 140, according to some embodiments.

FIG. 2 depicts example components of a web service and workflow management system, according to some embodiments.

FIG. 3 depicts example components of a service management and imaging system, according to some embodiments.

FIG. 4 depicts a flow diagram illustrating example operational scenario for communicating at least a portion of resource context information to an automated test system in order to verify operation of a service instance, according to some embodiments.

FIG. 5 depicts a flow diagram illustrating example operational scenario for generating an operating environment for a new service instance in accordance with service definitions that identify service parameters for provisioning the new service, according to some embodiments.

FIG. 6 depict operations of the example operational architecture for dynamically building out an ephemeral infrastructure for deploying a service instance using fungible compute resources, testing the service instance and then tearing down the infrastructure, according to some embodiments.

FIG. 7 depicts operations of the example operational architecture for dynamically building out an ephemeral infrastructure for deploying a service instance using fungible compute resources, testing the service instance and then tearing down the infrastructure, where the service instance is a new instance of a service management and imaging system according to some embodiments.

FIG. 8 is a block diagram illustrating a computing system suitable for implementing the scope-based certificate deployment technology disclosed herein, including any of the applications, architectures, elements, processes, and operational scenarios and sequences illustrated in the Figures and discussed below in the Technical Disclosure.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or a computer readable medium.

The techniques described herein facilitate dynamic buildout and teardown of ephemeral infrastructures for deploying service instances using fungible compute resources. Among other capabilities, a resource management fabric is described that uses a complex service definition that describes a large scale production web or data service and a set of fungible, elastic compute resources to dynamically buildout an instance of the service or application that adheres to the requirements of the service definitions. An operating environment can be generated that describes the ephemeral infrastructure for the deployed service instance. The generated operation environment is fundamentally the same environment, e.g., with the same settings, configurations, and network layouts, as a real, production instance of the application or service.

In some embodiments, the operating environment, including the resource context information, may be provided to an automated test system. The automated test system may use a test load provided by an application developer (either directly or via the resource management fabric) to perform functional tests on the service instance. The test results can be aggregated and provided back to the application developer. Once completed, the ephemeral infrastructure is dynamically torn down.

At least one technical effect discussed herein is the ability for developers to dynamically ensure that functional tests are executing in the same environment, e.g., with the same settings, configurations, and network layouts, as would a real, production instance of the application or service under test. Additionally, the dynamic ephemeral infrastructure buildout and teardown provides the additional technical effect of allowing a pool of fungible compute resources to be utilized on an as-needed basis by multiple developers or groups of developers.

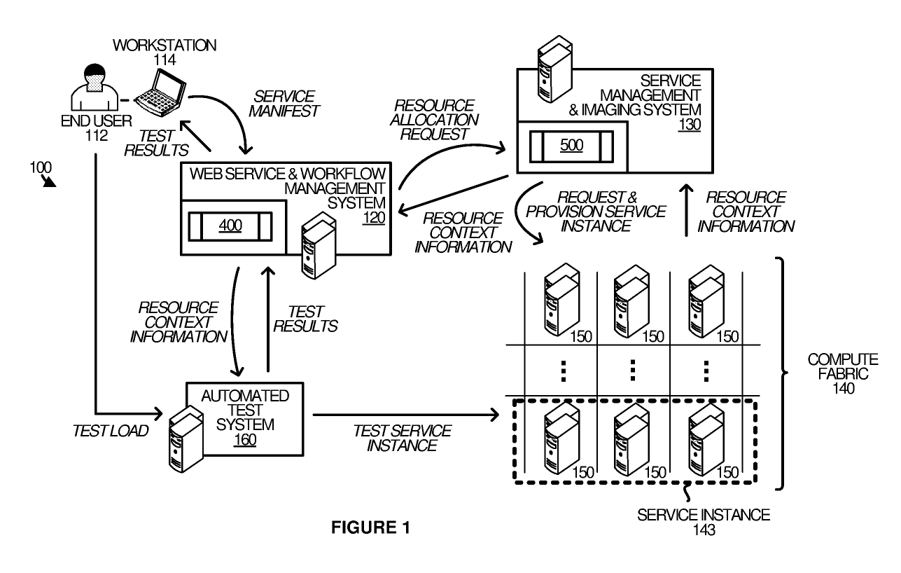

FIG. 1 depicts a block diagram illustrating an example operational architecture 100 for dynamically building out an ephemeral infrastructure for deploying a service instance 143 using fungible compute resources of a compute fabric 140, according to some embodiments. The example operational architecture 100 includes an end user (or developer) 112 operating workstation 114, a web service and workflow management system 120, a service management and imaging system 130, a compute fabric 140, and an automated test system 160.

The web service and workflow management system 120 is representative of a front-end service or collection of services that is configured to interface between end user (or developer) 112 operating workstation 114, service management and imaging system 130, and automated test system 160 to facilitate dynamic deployment of a service instance (or large scale application) 143 using fungible compute resources of the compute fabric 140. More specifically, the web service and workflow management system 120 is configured to receive a service manifest including service definitions identifying service parameters for provisioning a new service instance. The web service and workflow management system 120 processes the service definitions and responsively requests a dynamic ephemeral infrastructure (compute resource) deployment, e.g., resource allocation request. In some embodiments, the service manifest identifies the service definitions and/or parameters using a markup language, e.g., Extensible Markup Language (XML).

Responsive to the request, the web service and workflow management system 120 receives an operating environment indicating resource context information that identifies the compute resources and network layout parameters associated with the service instance as dynamically deployed. The web service and workflow management system 120 may then provide the resource context information to the automated test system 160. In this manner, the end user (or developer) 112 can, using a test load (provided by the web service and workflow management system 120 or directed from the end user 112 via workstation 114), cause functional tests to be performed on the service instance, e.g., service instance 143, in the same environment, e.g., with the same settings, configurations, and network layouts, as would a real, production instance of the application or service.

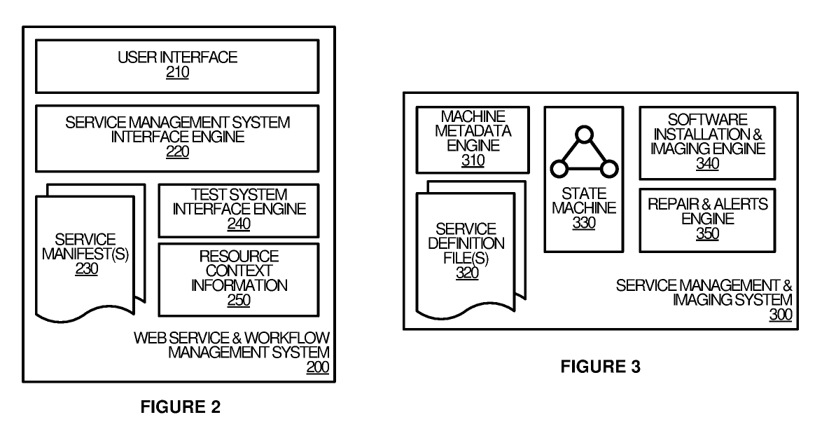

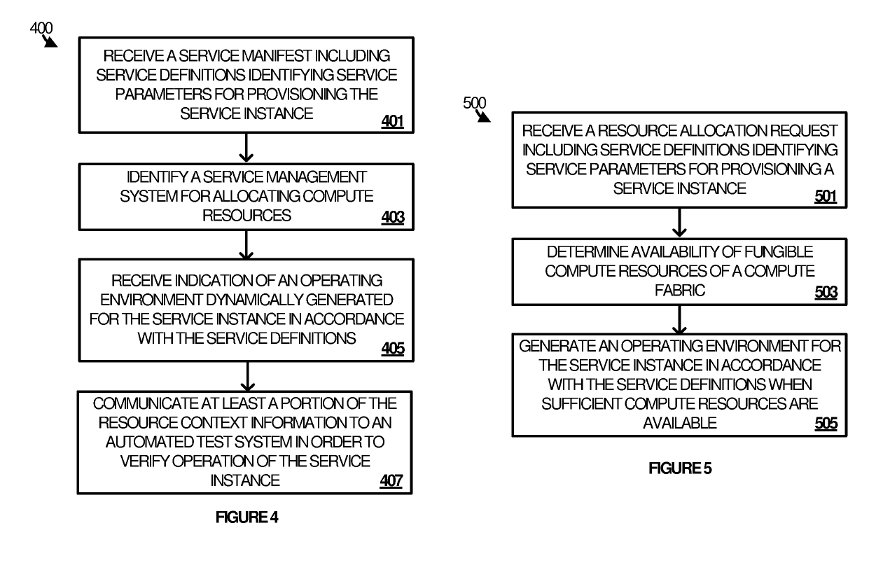

The web service and workflow management system 120 may include server computers, blade servers, rack servers, and any other type of computing system (or collection thereof) suitable for carrying out or interfacing between end user (or developer) 112 operating workstation 114, service management and imaging system 130, and automated test system 160. The web service and workflow management system 120 can include GUIs (graphical user interface) running on a PC, mobile phone device, a Web server, or even other application servers. Such systems may employ one or more virtual machines, containers, or any other type of virtual computing resource in the context of supporting enhanced group collaboration of which computing system 801 of FIG. 8 is representative. Example components of a web service and workflow management system 120 are shown and discussed in greater detail with reference to FIG. 2. Likewise, an example operation scenario 400 in which at least a portion of the resource context information is communicated to the automated test system 160 is described. The example operation scenario 400 is described in more detail with reference to FIG. 4.

The service management and imaging system 130 is representative of a service or collection of services that is configured to, among other features, maintain or determine status information regarding a back-end compute fabric 140. More specifically, responsive to a resource allocation request, the service management and imaging system 130 directs the compute fabric 140 to dynamically buildout and teardown an ephemeral infrastructure for deploying service instance 143 using elastic, fungible compute resources 150.

The service management and imaging system 130 is configured to determine availability of the fungible compute resources 150, and when sufficient compute resources are available, generate an operating environment for the service instance 143 in accordance with the service definitions. The operating environment identifies the resource context information including a set of compute resources and network layout parameters associated with the service instance 143. The operating environment information, including at least the resource context information, is then provided back to the web service and workflow management system 120.

As discussed herein, the compute fabric 140 include multiple compute resources 150. Each compute resource 150 may include server computers, blade servers, rack servers, and any other type of computing system (or collection thereof). In some embodiments, the compute resources may be virtual machines that are pre-provisioned using default software configurations making them fungible, elastic systems. Some service definitions may be iterations on top of these default configurations. Accordingly, the default configurations may save significant time in avoiding reimaging the virtual machine or having to install a standard, base-set of software. The service management and imaging system 130 can manage the virtual machines within the ephemeral environment and the physical machines that host the virtual machines. This means that in the event of a hardware failure on a host physical machine, the service management and imaging system 130 can account for the loss of the associated virtual machines and avoid trying to use them for any attempted workflow (e.g., functional test). Also, when the hardware is detected to be healthy again, the service management and imaging system 130 will automatically re-provision virtual machines and make them available.

The service management and imaging system 130 may include server computers, blade servers, rack servers, and any other type of computing system (or collection thereof) suitable for interfacing with the web service and workflow management system 120 and the compute fabric 140 and, more particularly, for directing the compute fabric to dynamically buildout and teardown an ephemeral infrastructure for deploying a service instance 143 using fungible compute resources 150 of a compute fabric 140. Such systems may employ one or more virtual machines, containers, or any other type of virtual computing resource in the context of supporting enhanced group collaboration of which computing system 801 of FIG. 8 is representative. Example components of a service management and imaging system 130 are shown and discussed in greater detail with reference to FIG. 3. Likewise, an example operation scenario 500 in which an operating environment for the service instance is generated in accordance with the service definitions is described. The example operation scenario 500 is described in more detail with reference to FIG. 5.

The automated test system 160 is configured to receive information regarding the generated operating environment and a test load, e.g., functional tests, and apply the functional tests to the service instance as deployed in the dynamic ephemeral infrastructure. As discussed herein, the resource context information may identify at least the compute resources and network layout parameters associated with the service instance as dynamically deployed. Additionally, the automated test system 160 can aggregate and provide the test results to an end user (developer).

FIG. 2 depicts example components of a web service and workflow management system 200, according to some embodiments. The web service and workflow management system 200 can be web service and workflow management system 120 of FIG. 1, although alternative configurations are possible. The functions represented by the components, modules and/or engines described with reference to FIG. 2 can be implemented individually or in any combination thereof, partially or wholly, in hardware, software, or a combination of hardware and software.

As illustrated in the example of FIG. 2, the web service and workflow management system 200 includes a user interface 210, a service management system interface engine 220, one or more service manifest(s) 230, a test system interface engine 240, and resource context information 250. Other systems, databases, and/or components are also possible. Some or all of the components can be omitted in some embodiments.

The user interface 210 is configured to provide a graphical interface to an end user 112 accessing the web service and workflow management system 120 via workstation 114.

The service management system interface engine 220 is configured to interface with the service management and imaging system 130. For example, the service management system interface engine 220 can provide resource allocation request to the service management and imaging system 130 and receive resource context information associated with deployed service instances.

The one or more service manifest(s) 230 may include service definitions identifying service parameters for provisioning particular ephemeral service instances. As discussed herein, the service manifest can be provided by an end user 112 via workstation 114 and stored by the web service and workflow management system 120.

The test system interface engine 240 is configured to interface with the automated test system 160. For example, the resource context information can be used to access the appropriate systems for functional testing.

FIG. 3 depicts example components of a service management and imaging system 300, according to some embodiments. The service management and imaging system 300 can be service management and imaging system 130 of FIG. 1, although alternative configurations are possible. The functions represented by the components, modules and/or engines described with reference to FIG. 3 can be implemented individually or in any combination thereof, partially or wholly, in hardware, software, or a combination of hardware and software.

As illustrated in the example of FIG. 3, the service management and imaging system 300 includes a machine metadata engine 310, one or more service definition file(s) 320, a state machine 330, a software installation and imagining engine 340, and a repair and alert engine 350. Other systems, databases, and/or components are also possible. Some or all of the components can be omitted in some embodiments.

The machine metadata engine 310 is configured to manage, process and maintain metadata associated with the compute resources 150. The metadata can include information regarding software installations, utilization, machine health, etc.

The one or more service definition file(s) 320 correspond to each service instance and, more particularly, map to a specific set of compute resources 150 under the management fabric's control. Management clients (not shown), which are installed on the compute resources 150, can collect data on the health, status, etc., of the software and hardware associated with the compute resources 150. This information can be used by, for example, state machine 330 to make availability determinations, repair determinations, status determinations, etc.

The state machine 330 is configured to generally manage the status of the compute fabric 140 and utilize the various engines and files to manage the ephemeral buildout and teardown of a set of compute resources for dynamically deploying a service instance.

The software installation and imagining engine 340 is configured to manage the installation of software on the compute resources 150. This process can include imaging, reimaging, installation, re-installation and reversions or rollbacks of software.

The repair and alert engine 350 is configured to automatically repair hardware and software and provide alerts regarding the same.

FIG. 4 depicts a flow diagram illustrating example an operational scenario 400 for communicating at least a portion of resource context information to an automated test system 160 in order to verify operation of a service instance 143, according to some embodiments. The example operations 400 may be performed in various embodiments by a web service and workflow management system such as, for example, web service and workflow management system 120 of FIG. 1, or one or more processors, modules, engines, components or tools of a management fabric.

To begin, at 401, the web service and workflow management system receives a service manifest including service definitions identifying service parameters for provisioning the service instance. In some embodiments, the service definitions may further identify one or more application component references for provisioning the service instance and may include one or more software installations and network layout parameters for provisioning the service instance.

At 403, the web service and workflow management system identifies a service management system for allocating compute resources. At 405, the web service and workflow management system, responsive to sending a resource allocation request to the service management system, receives indication of an operating environment dynamically generated for the service instance in accordance with the service definitions. As discussed herein, the operating environment identifies resource context information including a set of compute resources of the compute resources 150 and network layout parameters associated with the service instance.

Lastly, at 407, the web service and workflow management system communicates at least a portion of the resource context information to an automated test system in order to verify operation of the service instance.

FIG. 5 depicts a flow diagram illustrating example operational scenario 500 for generating an operating environment for a new service instance in accordance with service definitions that identify service parameters for provisioning the new service, according to some embodiments. The example operations 500 may be performed in various embodiments by a service management and imaging system such as, for example, service management and imaging system 130 of FIG. 1, or one or more processors, modules, engines, components or tools of a management fabric.

To begin, at 501, the service management and imaging system receives a resource allocation request including service definitions identifying service parameters for provisioning a new service instance. In some embodiments, the service definitions may further identify one or more application component references for provisioning the service instance and may include one or more software installations and network layout parameters for provisioning the service instance.

At 503, the service management and imaging system determines availability of the fungible compute resources.

Lastly, at 505, the service management and imaging system dynamically generates an operating environment for the service instance in accordance with the service definitions when sufficient compute resources are available. As discussed herein, the operating environment identifies resource context information including a set of compute resources of the fungible compute resources and network layout parameters associated with the service instance. Generating the operating environment for the service instance can include allocating the set of compute resources and moving the set of compute resources to the operating environment.

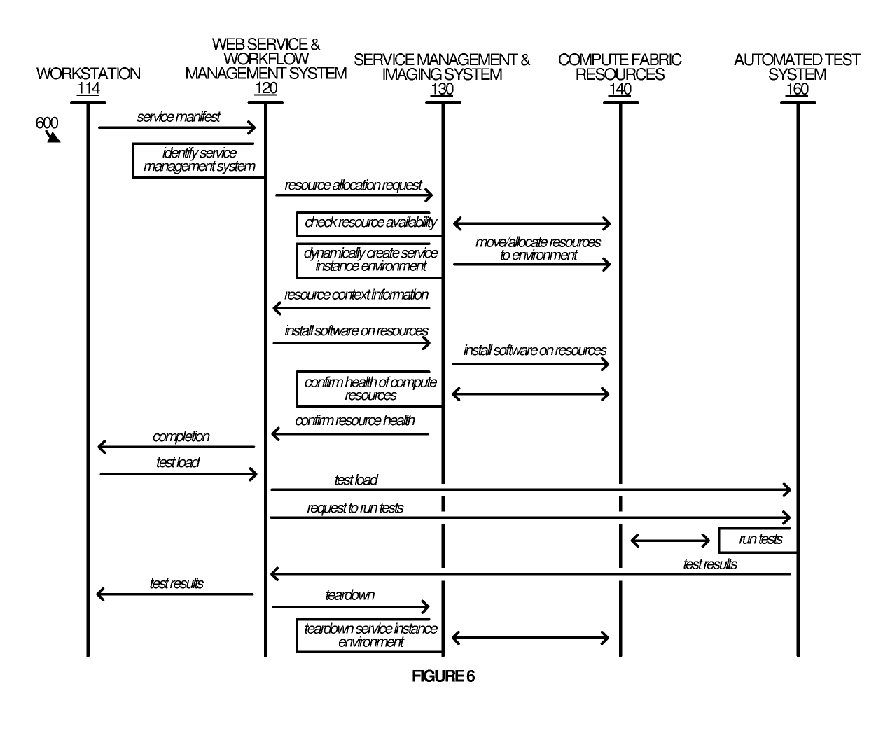

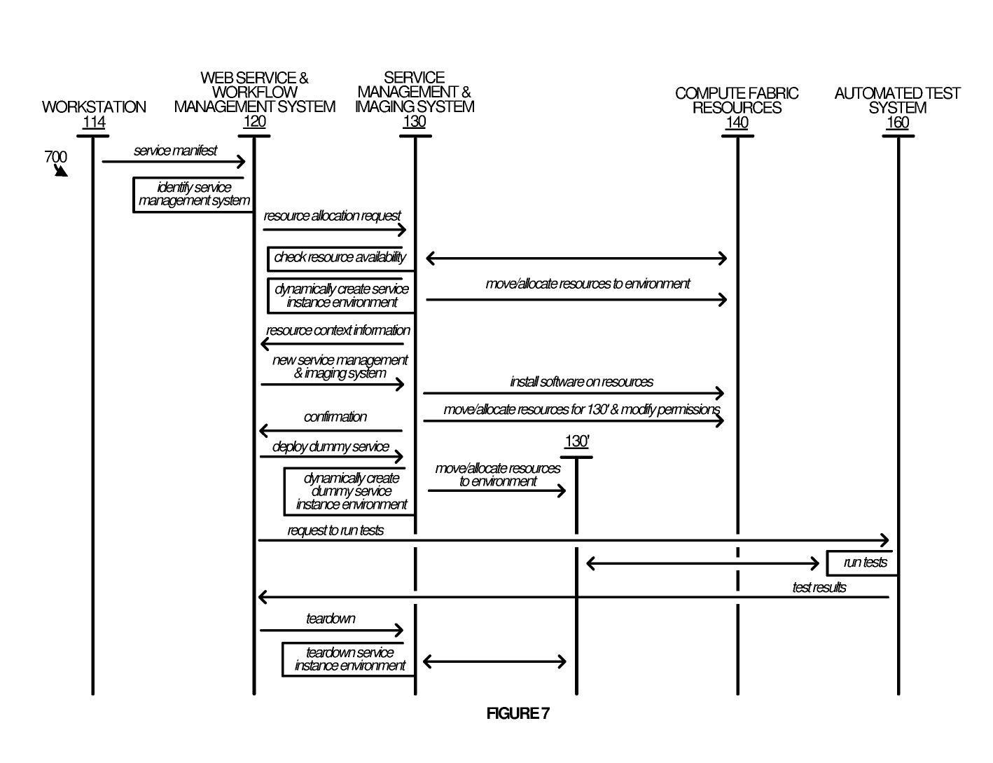

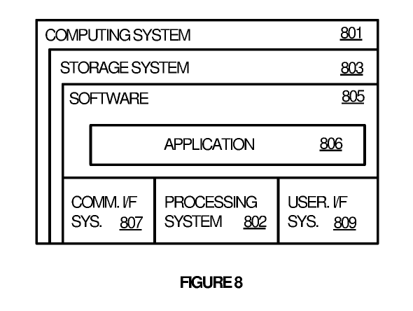

To further illustrate the operation of example operational architecture 100, FIGS. 6 and 7 are provided. FIGS. 6 and 7 illustrate sequence diagrams 600 and 700, respectively. The example sequence diagrams 600 and 700 depict operations of the example operational architecture 100 for dynamically building out an ephemeral infrastructure for deploying a service instance using fungible compute resources, testing the service instance and then tearing down the infrastructure, according to some embodiments. The sequence diagrams include workstation 114, web service and workflow management system 120, service management and imaging system 130, compute fabric (compute resources) 140, and automated test system 160. Additional or fewer components of the example operation architecture 100 are possible.

Referring first to the example of FIG. 6, initially, an end user (not shown) operating workstation 114 specifies various information including a detailed service description and references to one or more application components. The information may be provided to the web service and workflow managements system 120 via a service manifest. As discussed herein, the service manifest may include service definitions identifying service parameters for provisioning the new service instance.

Responsive to receiving the service manifest, the web service and workflow management system 120 identifies a service management system, e.g., service management and imaging system 130, for allocating compute resources. The workflow management system 120 generates and sends a resource allocation request to the service management and imaging system 130 to allocate compute resources for the new service instance.

The service management and imaging system 130 receives the resource allocation request and checks or otherwise detects the availability of the fungible compute resources 150 within compute fabric 140. The service management and imaging system 130 then determines if the compute fabric 140 has sufficient compute capacity (e.g., available compute resources). If the compute fabric 140 has sufficient compute capacity, then the service management and imaging system 130 dynamically generates one or more new environments, e.g., “EnvironmentA1,” etc., and moves or otherwise allocates a set of resources to each of the new environments. As shown in the example of FIG. 1, three compute resources are allocated for the service instance (or environment) 143. The resource context information identifying the environments and the compute resources allocated to the environments is updated and/or otherwise stored. The service management and imaging system 130 then sends a completion signal including at least a portion of the resource context information to the web service and workflow managements system 120.

The web service and workflow management system 120 receives the completion signal along with at least a portion of resource context information and sends a software installation command to the service management and imaging system 130 to install software on the set of compute resources allocated to the dynamically generated environments. As discussed herein, the software parameters identified by the service definitions provided to the web service and workflow management system 120 via the service manifest may include one or more software installations and network layout parameters for provisioning the service instance. The software installations can indicate the software that needs to be installed.

The service management and imaging system 130 receives the software installation command and installs the identified software on the dynamically allocated compute resources. For example, the service management and imaging system 130 may send commands to each allocated compute resource to install software in accordance with the service definitions. Once software is installed on each compute resource, the service management and imaging system 130 confirms the health of each compute resource and sends a confirmation to the web service and workflow management system 120. The web service and workflow management system 120 subsequently notifies the end user via a completion message that is sent to workstation 114.

Additionally, once the web service and workflow management system 120 becomes aware that the service instance is deployed in the dynamic infrastructure, the system sends a request to the automated test system 160 to run functional tests against the newly created service instance. In some embodiments, the end user, via workstation 114, may provide a test load, e.g., functional tests to the web service and workflow management system 120 or directly to the automated test system 160. The web service and workflow management system 120 may obtain test results and provide the results to the end user via workstation 114. Alternatively or additionally, test results can be provided directly to the end user via the workstation 114 by the automated test system 160.

After testing is completed, the web service and workflow management system 120 sends a command to the service management and imaging system 130 to tear down the ephemeral service instance. The service management and imaging system 130 responsively tears down the ephemeral infrastructure. The tear down can include moving compute resources to a cleanup environment where the resources are reimaged, have virtual machines or snapshots reverted to previous states, etc. In some embodiments, test results can be sent after teardown.

Referring next to FIG. 7, the example of FIG. 7 is similar to the example of FIG. 6 except that where the service instance is a new instance of a service management and imaging system such as, for example, service management and imaging system 130 of FIG. 1. More specifically, in the example of FIG. 7, a new service management and imaging system 130′ is dynamically built out and torn down using the fungible compute resources of the compute fabric 140.

Initially, an end user (not shown) operating workstation 114 specifies various information including a detailed service description and references to one or more application components. The information may be provided to the web service and workflow managements system 120 via a service manifest. As discussed herein, the service manifest may include service definitions identifying service parameters for provisioning the new service instance. In the example of FIG. 7, the service manifest includes a description of the new version or instance of the service management and imaging system 130 that the end user wants to deploy and network path locations for the application components that should be deployed as part of the new version.

Responsive to receiving the service manifest, the web service and workflow management system 120 identifies a service management system, e.g., service management and imaging system 130, for allocating compute resources. The workflow management system 120 generates and sends a resource allocation request to the service management and imaging system 130 to allocate compute resources for the new version or instance of the service management and imaging system.

The service management and imaging system 130 receives the resource allocation request and checks or otherwise detects the availability of the fungible compute resources 150 within compute fabric 140. The service management and imaging system 130 then determines if the compute fabric 140 has sufficient compute capacity (e.g., available compute resources). If the compute fabric 140 has sufficient compute capacity, then the service management and imaging system 130 dynamically generates one or more new environments, e.g., “EnvironmentA1,” etc., and moves or otherwise allocates a set of resources to each of the new environments. The resource context information identifying the environments and the compute resources allocated to the environments is updated and/or otherwise stored. The service management and imaging system 130 then sends a completion signal including at least a portion of the resource context information to the web service and workflow managements system 120.

The web service and workflow management system 120 receives the completion signal along with at least a portion of resource context information and sends a command to build out the new version or instance of the service management and imaging system 130 in accordance with the service definitions provided in the service manifest. The service management and imaging system 130 receives the command and directs the set of compute resources allocated to the dynamically generated environments to install software for the new version or instance of the service management and imaging system. The service management and imaging system 130 monitors progress and health of the compute resources until installation is complete, at which point the new version or instance of the service management and imaging system, service management and imaging system 130′, is created.

The service management and imaging system 130 moves/allocates additional compute resources for service management and imaging system 130′ and modifies permissions of the compute resources so that that can be managed by service management and imaging system 130′. The web service and workflow management system 120 then sends a command to the service management and imaging system 130′ to deploy a dummy service to the allocated compute resources managed by the service management and imaging system 130′.

The web service and workflow management system 120 becomes aware that the dummy service instance is deployed in the ephemeral infrastructure and sends a request to the automated test system 160 to run functional tests against the newly created dummy service instance. In some embodiments, the end user, via workstation 114, may provide a test load, e.g., functional tests to the web service and workflow management system 120 or directly to the automated test system 160. As shown, dummy tests may be applied to the dummy service instance. The web service and workflow management system 120 may obtain test results and provide the results to the end user via workstation 114. Alternatively or additionally, test results can be provided directly to the end user via the workstation 114 by the automated test system 160.

After testing is completed, the web service and workflow management system 120 sends a command to the service management and imaging system 130 to tear down the dummy service instance and the service management and imaging system 130′. The service management and imaging system 130′ relinquishes management control of the compute resources by reverting permissions. The service management and imaging system 130 then tears down the ephemeral infrastructure. The tear down can include moving compute resources to a cleanup environment where the resources are reimaged, have virtual machines or snapshots reverted to previous states, etc. In some embodiments, test results can be sent after teardown.

FIG. 8 illustrates computing system 801, which is representative of any system or collection of systems in which the various applications, services, scenarios, and processes disclosed herein may be implemented. For example, computing system 801 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and an optional user interface system 809.

Processing system 802 loads and executes software 805 from storage system 803. When executed by processing system 802 for deployment of scope-based certificates in multi-tenant cloud-based content and collaboration environments, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for directing the system to perform the processes described with reference to FIGS. 3-6.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system. Indeed, encoding software on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here. In some cases, the user interface system 809 may be omitted when the computing system 801 is implemented as one or more server computers such as, for example, blade servers, rack servers, or any other type of computing server system (or collection thereof).

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface, in which a user interface to a productivity application may be presented.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of dynamically building an ephemeral infrastructure for deploying a service instance using fungible compute resources, the method comprising:
receiving a resource allocation request including service definitions identifying service parameters for provisioning the service instance;
determining availability of the fungible compute resources; and
dynamically generating an operating environment for the service instance in accordance with the service definitions when sufficient compute resources are available,
wherein the operating environment identifies resource context information including a set of compute resources of the fungible compute resources and network layout parameters associated with the service instance.

2. The method of claim 1, wherein the service definitions further identify one or more application component references for provisioning the service instance.

3. The method of claim 1, wherein the service parameters include one or more software installations and network layout parameters for provisioning the service instance.

4. The method of claim 3, further comprising:
processing the service parameters to identify one or more software installations associated with the service instance; and
directing the set of compute resources to install the one or more software installations.

5. The method of claim 4, further comprising:
responsive to installing the one or more software installations on the set of compute resources, verifying the health of the compute resources; and
providing an indication of the health of the compute resources to a workflow management system.

6. The method of claim 1, wherein generating the operating environment for the service instance comprises:
allocating the set of compute resources; and
moving the set of compute resources to the operating environment.

7. The method of claim 1, further comprising:
receiving a request to tear down the operating environment; and
responsive to the request, moving the set of compute resources to a cleanup environment.

8. The method of claim 7, wherein the compute resources are reimaged in the cleanup environment.

9. The method of claim 7, wherein the compute resources have corresponding virtual machine snapshots reverted in the cleanup environment.

10. The method of claim 1, further comprising:
providing the resource context information to a workflow management system,
wherein the resource allocation request is generated by the workflow management system.

11. The method of claim 1, wherein the service instance comprises a new instance of a service management system.

12. A method of dynamically building an ephemeral infrastructure for deploying a service instance using fungible compute resources, the method comprising:
receiving a service manifest including service definitions identifying service parameters for provisioning the service instance;
identifying a service management system for allocating compute resources;
responsive to sending a resource allocation request to the service management system, receiving indication of an operating environment dynamically generated for the service instance in accordance with the service definitions,
wherein the operating environment identifies resource context information including a set of compute resources of the fungible compute resources and network layout parameters associated with the service instance; and
communicating at least a portion of the resource context information to an automated test system in order to verify operation of the service instance.

13. The method of claim 12, wherein the service definitions further identify one or more application component references for provisioning the service instance.

14. The method of claim 12, wherein the service parameters include one or more software installations and network layout parameters for provisioning the service instance.

15. The method of claim 12, further comprising:
receiving operational results of the service instance from the automated test system; and
communicating the operational results of the service instance to an end user.

16. The method of claim 12, wherein the service instance comprises a new instance of a service management system.

17. A computing apparatus configured to facilitate dynamic buildout of an ephemeral infrastructure for deploying a service instance using fungible compute resources, the apparatus comprising:
one or more computer readable storage media;
one or more processing systems operatively coupled with the one or more computer readable storage media; and
a management fabric service having program instructions stored on the one or more computer readable storage media which, when executed by the one or more processing systems, direct the one or more processing systems to:
process a resource allocation request to identify service parameters for provisioning the service instance,
determining availability of the fungible compute resources; and
dynamically generating an operating environment for the service instance in accordance with the service definitions when sufficient compute resources are available,
wherein the operating environment identifies resource context information including a set of compute resources of the fungible compute resources and network layout parameters associated with the service instance.

18. The computing apparatus of claim 17, wherein the instructions stored on the one or more computer readable storage media, when executed by the one or more processing systems, further direct the one or more processing systems to:
process service parameters to identify one or more software installations associated with the service instance,
wherein the service parameters include one or more software installations and network layout parameters for provisioning the service instance; and
direct the set of compute resources to install the one or more software installations.

19. The computing apparatus of claim 18, wherein the instructions stored on the one or more computer readable storage media, when executed by the one or more processing systems, further direct the one or more processing systems to:
responsive to installing the one or more software installations on the set of compute resources, verify the health of the compute resources; and
provide an indication of the health of the compute resources to a workflow management system.

20. The computing apparatus of claim 17, wherein the instructions stored on the one or more computer readable storage media, when executed by the one or more processing systems, further direct the one or more processing systems to:
allocate the set of compute resources;
move the set of compute resources to the operating environment;
responsive to a request to tear down the operating environment, move the set of compute resources to a cleanup environment.
